(19) United States
(12) Patent Application Publication
(10) Pub. No.: US 2022/0304439 A1
(43) Pub. Date: Sep. 29, 2022

(54) WATERPROOF SHADING BAG

(71) Applicant: Songke Fang, Guangdong (CN)

(72) Inventor: Songke Fang, Guangdong (CN)

(21) Appl. No.: 17/338,912

(22) Filed: Jun. 4, 2021

(30) Foreign Application Priority Data
Mar. 29, 2021 (CN) 202120630674.5

(51) Int. Cl. A45C 13/00; A45C 13/30; A45C 13/10

(52) U.S. Cl. CPC A45C 13/008; A45C 13/30; A45C 13/103; A45C 2013/1015

(57) ABSTRACT

The present disclosure relates to the technical field of sports accessories, and in particular to a waterproof shading bag comprising an upper shell, a lower shell, a zipper, a touch film, and a waterproof partition frame. The upper shell is connected to the lower shell by the zipper. An extension end is arranged at an upper edge of the lower shell. A drainage groove is arranged between the extension end and the zipper. A drain hole is arranged below the drainage groove. The touch film is arranged in a middle of the upper shell. A storage space is arranged in the lower shell. The waterproof partition frame is arranged at an inner end of the lower shell. Hook & loop straps are arranged at a bottom of the lower shell.

### CROSS-REFERENCE TO RELATED APPLICATIONS

The instant application claims priority to Chinese Patent Application 202120630674.5, filed on Mar. 29, 2021, which is incorporated herein by reference.

### FIELD OF THE DISCLOSURE

The present disclosure relates to the technical field of sports accessories, and in particular to a waterproof shading bag.

### BACKGROUND OF THE DISCLOSURE

Waterproof sport devices currently offered on the market are characterized by single functions (i.e., have a single purpose), small capacity and cannot carry many things during exercise. Besides, general waterproof sport devices are only equipped with a lanyard and cannot be firmly fixed on sports equipment.

### SUMMARY OF THE DISCLOSURE

The present disclosure proposes a waterproof shading bag to solve the problems existing in the prior art.

To solve the above technical problems, the present disclosure adopts the following technical scheme:

The present disclosure proposes a waterproof shading bag, comprising an upper shell, a lower shell, a zipper, a touch film, and a waterproof partition frame. The upper shell is connected to the lower shell by the zipper. An extension end is arranged at an upper edge of the lower shell. A drainage groove is arranged between the extension end and the zipper. A drain hole is arranged below the drainage groove. The touch film is arranged in a middle of the upper shell. A storage space is arranged in the lower shell. The waterproof partition frame is arranged at an inner end of the lower shell. Hook & loop straps are arranged at a bottom of the lower shell.

In a preferred embodiment, a hook & loop element is arranged at a bottom of the touch film.

In a preferred embodiment, a waterproof wrapping layer is arranged outside the zipper.

In a preferred embodiment, a top of the lower shell has a slope.

In a preferred embodiment, a U-shaped groove is arranged at the bottom of the lower shell.

In a preferred embodiment, a waterproof layer is arranged between the zipper and the waterproof partition frame.

The present disclosure has the following beneficial effects. A waterproof shading bag, comprising an upper shell, a lower shell, a zipper, a touch film, and a waterproof partition frame. The upper shell is connected to the lower shell by the zipper. An extension end is arranged at the upper edge of the lower shell. A drainage groove is arranged between the extension end and the zipper. A drain hole is arranged below the drainage groove. The touch film is arranged in the middle of the upper shell. A storage space is arranged in the lower shell. The waterproof partition frame is arranged at the inner end of the lower shell. Hook & loop straps are arranged at the bottom of the lower shell, which enables the waterproof shading bag to be firmly fixed on sports equipment, enhances a waterproof function of the waterproof shading bag, and increases storage space at the inner end so that users can place their exercise necessities for easy portability.

### DESCRIPTION OF THE DRAWINGS

FIG. 1 illustrates an overall structure diagram of the waterproof shading bag.

FIG. 2 illustrates an exploded view of the waterproof shading bag.

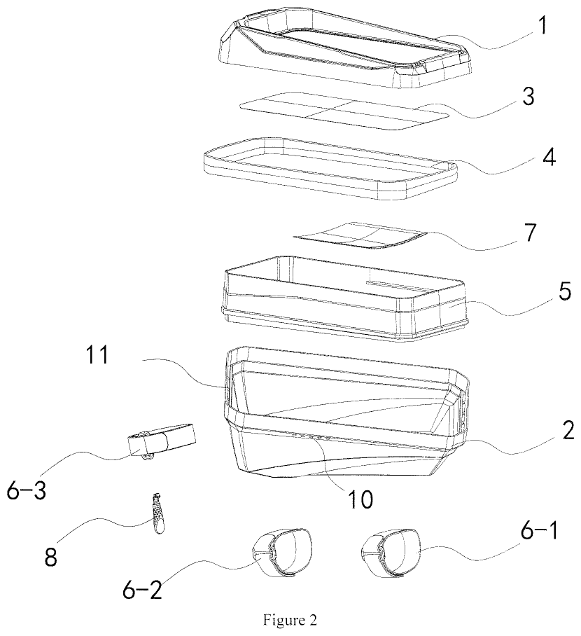

Reference numerals in the drawings: 1—Upper shell; 2—Lower shell; 3—Touch film; 4—Waterproof wrapping layer; 5—Waterproof partition frame; 6—Hook & loop strap; 7—Hook & loop element; 8—Zipper; 10—Drain hole; 11—Drainage groove.

### DETAILED DESCRIPTION OF THE EMBODIMENT

For easy understanding by those skilled in the art, the present disclosure will be further described with reference to the embodiment and the accompanying drawings. The content mentioned in the embodiment should not be construed as limiting the present disclosure. The present disclosure will be described in detail with reference to the accompanying drawings.

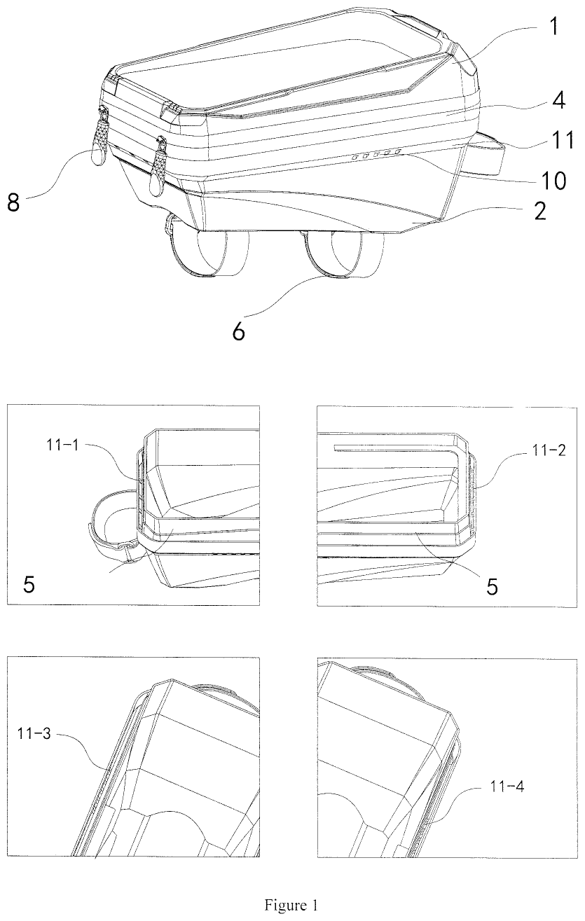

As shown in FIG. 1, the present disclosure proposes a waterproof shading bag, comprising an upper shell (1), a lower shell (2), a zipper (8), a touch film (3), and a waterproof partition frame (5). The upper shell (1) is connected to the lower shell (2) by the zipper (8). An extension end is arranged at an upper edge of the lower shell (2). A drainage groove (11) is arranged between the extension end and the zipper (8). A drain hole (10) is arranged below the drainage groove (11). The touch film (3) is arranged in a middle of the upper shell (1). A storage space is arranged in the lower shell (2). The waterproof partition frame (5) is arranged at an inner end of the lower shell (2). Hook & loop straps (6) are arranged at a bottom of the lower shell (2).

In this embodiment, a hook & loop element (7) (e.g., a hook & loop pad) is arranged at a bottom of the touch film (3) and can be used to fix (e.g., secure) a mobile phone, making the mobile phone difficult to move.

In this embodiment, a waterproof wrapping layer (4) is arranged outside the zipper (8), which can effectively prevent water from entering and achieve a waterproofing effect.

In this embodiment, a top of the lower shell (2) has a slope, which enables water to flow in one direction and be discharged more quickly.

In this embodiment, a U-shaped groove is arranged at the bottom of the lower shell (2), which works with the hook & loop straps (6) to enable the waterproof shading bag to be fixed to sports equipment.

In this embodiment, a waterproof layer is arranged between the zipper (8) and the waterproof partition frame (5) to achieve secondary waterproofing.

The embodiment described above is only the preferred embodiment of the present disclosure and is not to be construed as limiting the present disclosure in any form. Although the present disclosure has been described with respect to the preferred embodiment above, it is understood that the preferred embodiment is not used to limit the present disclosure. Any person skilled in the art is expected to make some changes thereto or modifications to generate equivalent embodiments with some changes based on the technical content disclosed above without departing from the scope of the present disclosure. However, any simple modifications, equivalent changes, and modifications made to the above embodiment according to the present disclosure without departing from the content of the technical solution of the present disclosure are within the scope of the present disclosure.

What is claimed is:

1. A waterproof shading bag, comprising:
an upper shell,
a lower shell,
a zipper,
a touch film, and
a waterproof partition frame, wherein:
the upper shell is connected to the lower shell by the zipper,
an extension end is arranged at an upper edge of the lower shell,
a drainage groove is arranged between the extension end and the zipper,
a drain hole is arranged below the drainage groove,
the touch film is arranged in a middle of the upper shell,
a storage space is arranged in the lower shell,
the waterproof partition frame is arranged at an inner end of the lower shell, and
hook & loop straps are arranged at a bottom of the lower shell.

2. The waterproof shading bag according to claim 1, wherein a hook & loop element is arranged at a bottom of the touch film.

3. The waterproof shading bag according to claim 1, wherein a waterproof wrapping layer is arranged outside the zipper.

4. The waterproof shading bag according to claim 1, wherein a top of the lower shell has a slope.

5. The waterproof shading bag according to claim 1, wherein a U-shaped groove is arranged at the bottom of the lower shell.

6. The waterproof shading bag according to claim 1, wherein a waterproof layer is arranged between the zipper and the waterproof partition frame.
